(19) United States
(12) Patent Application Publication
(10) Pub. No.: US 2014/0164144 A1
(43) Pub. Date: Jun. 12, 2014

(54) SPONSORSHIP OF MEDIA DESCRIPTION TAGS

(71) Applicant: RAWLLIN INTERNATIONAL INC., Tortola (VG)

(72) Inventor: Leonid Belyaev, Moscow (RU)

(73) Assignee: RAWLLIN INTERNATIONAL INC., Tortola (VG)

(21) Appl. No.: 13/709,545

(22) Filed: Dec. 10, 2012

(51) Int. Cl. G06Q 30/02

(52) U.S. Cl. CPC G06Q 30/0275
USPC 705/14.71; 705/14.73

(57) ABSTRACT

Systems and methods for managing and/or controlling tagged data in media content are disclosed herein. A tagging component assigns a tag to a content element in a media item. A bidding component determines a sponsor for the content element. A presentation component presents the tag with information regarding the content element. The information regarding the content element is determined by the sponsor.

### TECHNICAL FIELD

This disclosure generally relates to tagged data in media content.

### BACKGROUND

Multimedia such as video in the form of clips, movies, television and streaming video is becoming widely accessible to users (e.g., computer users). As such, the amount of content provided to users via multimedia is increasing. However, currently users are required to actively search for additional information associated with content provided by multimedia. Since users often have limited knowledge of the content presented in multimedia, obtaining additional information associated with multimedia content is often difficult and/or inefficient. Furthermore, users are often times unsuccessful in obtaining additional information associated with multimedia content. In addition, conventional multimedia systems and methods are not able to control and/or manage additional information associated with multimedia content.

The above-described deficiencies associated with tagged data in media content are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with tagging data in media content. For instance, an embodiment includes a system comprising a tagging component, a bidding component and a presentation component. The tagging component is configured to assign a tag to a content element in a media item. The bidding component is configured to determine a sponsor for the content element. The presentation component is configured to present the tag with information regarding the content element. The information regarding the content element is determined by the sponsor.

In another non-limiting embodiment, an exemplary method is provided that includes assigning a tag to a content element in a media item, determining a sponsor for the content element and presenting the tag with information regarding the content element, where the information regarding the content element is determined by the sponsor.

In yet another non-limiting embodiment, an exemplary method is provided that includes offering a tag associated with a content element in a media item for sponsorship, receiving one or more bids for the tag from one or more bidders, and assigning a sponsor for the tag based at least in part on the one or more bids for the tag.

In still another non-limiting embodiment, an exemplary tangible computer-readable storage medium comprising computer-readable instructions that, in response to execution, cause a computing system including a processor to perform operations, comprising assigning a tag to a content element in a media item, determining a sponsor for the content element and presenting the tag with information regarding the content element, where the information regarding the content element is determined by the sponsor.

Other embodiments and various non-limiting examples, scenarios and implementations are described in more detail below. The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a high-level functional block diagram of an example system for controlling and/or managing tagged data in media content, in accordance with various aspects and implementations described herein;

FIG. 2 illustrates another high-level functional block diagram of an example system for controlling and/or managing tagged data in media content, in accordance with various aspects and implementations described herein;

FIG. 3 illustrates yet another high-level functional block diagram of an example system for controlling and/or managing tagged data in media content, in accordance with various aspects and implementations described herein;

FIG. 4 presents an exemplary representation of content elements in a media item assigned to tags, in accordance with various aspects and implementations described herein;

FIG. 5 presents an exemplary representation of one or more tags associated with one or more content elements, in accordance with various aspects and implementations described herein;

FIG. 6 presents another exemplary representation of one or more tags associated with one or more content elements, in accordance with various aspects and implementations described herein;

FIG. 7 presents an exemplary system with one or more bidders and a biddable tag, in accordance with various aspects and implementations described herein;

FIG. 8 presents an exemplary system for assigning one or more sponsors to one or more tags, in accordance with various aspects and implementations described herein;

FIG. 9 presents an exemplary system for publishing one or more tags, in accordance with various aspects and implementations described herein;

FIG. 10 illustrates a method for controlling and/or managing tagged data in media content, in accordance with various aspects and implementations described herein;

FIG. 11 illustrates a method for assigning a sponsor to a tag in a media item, in accordance with various aspects and implementations described herein;

FIG. 12 illustrates a method for bidding on a biddable keyword, in accordance with various aspects and implementations described herein;

FIG. 13 illustrates another method for controlling and/or managing tagged data in media content, in accordance with various aspects and implementations described herein;

FIG. 14 illustrates a block diagram representing exemplary non-limiting networked environments in which various non-limiting embodiments described herein can be implemented; and

FIG. 15 illustrates a block diagram representing an exemplary non-limiting computing system or operating environment in which one or more aspects of various non-limiting embodiments described herein can be implemented.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

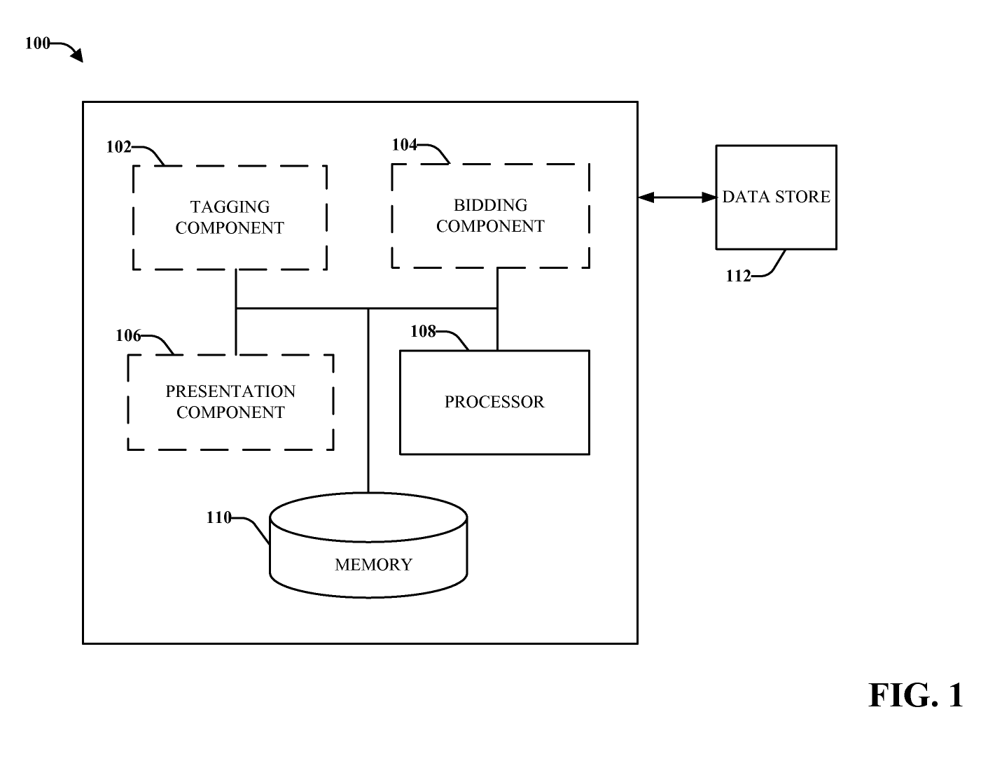

Referring now to the drawings, with reference initially to FIG. 1, a system 100 for controlling and/or managing tagged content elements (e.g., media description tags) in a media item is presented, in accordance with various aspects described herein. Aspects of the systems, apparatuses or processes explained herein can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. System 100 can include a memory 110 for storing computer executable components and instructions. A processor 108 can facilitate operation of the computer executable components and instructions by the system 100.

The system 100 is configured to control and/or manage a tagged content element (e.g., a media description tag) and/or information associated with a tagged content element in a media item. The system 100 includes a tagging component 102, a bidding component 104 and a presentation component 106. The tagging component 102 can be configured to assign a tag to a content element in a media item. The bidding component 104 can be configured to determine a sponsor for the content element. The presentation component 106 can be configured to present the tag with information regarding the content element. The information regarding the content element can be determined by the sponsor. As such, information (e.g., content, data, etc.) associated with a tag can be varied (e.g., managed and/or controlled) based on sponsorship of the tag.

As used herein, a “tag” is a keyword assigned to a content element (e.g., associated with a content element) in a media item. Information associated with the tag can include, for example, text, images, links, comments, ratings, coupons, discounts, advertisements, etc. In an aspect, a tag can help to describe a content element assigned to (e.g., associated with) the tag. As used herein, a “content element” is an element presented in a media item (e.g., a video). A content element can include, but is not limited to, an object, a product, a good, a device, an item of manufacture, a person, an entity, a geographic location, a place, an element, etc. In one implementation, a content element can be identified during film production of media content (e.g., a media item). For example, during film production of a movie, television show or other video clip one or more content elements can be identified (e.g., one or more content elements can be identified in a scene of the media content where the media content is virtually split into scenes). In another implementation, a content element can be identified after film production of media content (e.g., a media item). For example, during playback of media content a user (e.g., a content consumer, a viewer, a sponsor, etc.) can identify and/or add one or more content elements. As used herein, the term “media item” or “media content” is intended to relate to an electronic visual media product and includes video, television, streaming video and so forth. For example, a media item can include a movie, a live television program, a recorded television program, a streaming video clip, a user-generated video clip, a video game, etc.

The tagging component 102 can assign a tag to (e.g., associate a tag with) each identified content element in a media item. For example, a tag can be associated with a keyword (e.g., a biddable keyword). In another example, a tag can be associated with metadata (e.g., biddable metadata). The tagging component 102 can assign a value to a tag identifying the content element. For example, each content element in a media item can include a uniquely assigned value and/or a uniquely assigned tag. As such, the tagging component 102 can generate one or more tagged content elements.

Additionally, the tagging component 102 can assign information regarding a content element (e.g., information associated with a content element) to a tag (e.g., a tagged content element). In one example, the tagging component 102 can assign a detailed description to the content element. Additionally or alternatively, the tagging component 102 can assign a uniform resource locator (URL) link for a webpage to the content element. The URL link can provide a source with further detailed information regarding the content element. In one example, the URL link can provide a link to a website associated with the content element, a vendor for the content element, etc. Additionally or alternatively, the information can provide an opportunity to purchase the content element (e.g., via a URL link for a vendor, by providing a vendor name, by providing a coupon, etc.). The information regarding the content element can be determined by a content provider and/or a sponsor.

In one embodiment, the tagging component 102 can determine and/or set the number of content elements in a media item. For example, content elements tagged in a media item can depend on whether a content element is biddable. A biddable content element can include, for example, an object, a product, a good, a device, an item of manufacture, a person, an entity, a geographic location or a place displayed via a media item. A biddable content element can further be determined based on, for example, a relevancy factor of a content element, an interest level of a content element, a determined association of a content element with a media item, etc. As such, a biddable content element can be implemented as a biddable data element. In one example, a content element that is not biddable can be untagged (e.g., a tag is not assigned to the content element). A content provider can determine number of biddable content elements in a media item. In one example, a content provider (e.g., a content owner) can determine a list of biddable content elements in a media item. Therefore, a potential sponsor can search a list of biddable content elements (or keywords associated with biddable content elements) in order to bid for a tag.

In one embodiment, the tagging component 102 can be configured to identify one or more content elements in the media item. For example, the tagging component 102 can implement auto-recognition to identify one or more content elements. In one example, a particular content element can be initially identified in a scene (e.g., a video frame, a certain time interval, etc.) of a media item by a user (e.g., a content provider, a content operator, a content viewer, etc.). Therefore, the tagging component 102 can implement auto-recognition to identify the particular content element in different scenes (e.g., different video frames, different time intervals, etc.) of the media item. In one embodiment, the tagging component 102 can associate a content element in the media item with a tag based on an image frame position or a time interval of the media item (e.g., without identifying placement of a content element in a media item). Therefore, the tagging component 102 can identify and/or assign one or more tags associated with one or more content elements for each image frame position or each time interval of the media item.

The bidding component 104 can be configured to vary information (e.g., content) associated with a tag based on one or more factors. The bidding component 104 can determine (e.g., assign) a sponsor for the content element. Therefore, control and/or management of information (e.g., content) associated with a tag can be determined based at least in part on sponsorship. For example, the bidding component 104 can allow a bidder to bid against other bidders for an opportunity to be assigned to tag. An assigned bidder (e.g., a sponsor) can determine information (e.g., content) associated with a tag. The bidding component 104 can receive and/or aggregate one or more bids for a tag from one or more bidders.

The bidding component 104 can select a sponsor (or sponsors) from the one or more bidders based on one or more factors (e.g., variables, criteria, etc.). For example, a bidder having placed a highest bid at an end of a predetermined time period can be considered a sponsor. In one example, the bidding component 104 can select a sponsor from the one or more bidders based at least in part on monetary payment (e.g., a bidder that pays the highest amount of money can be considered the sponsor for a content element). Additionally or alternatively, the bidding component 104 can select a sponsor based on, for example, a determined relationship between a sponsor and a media item, a determined relevancy factor of a content element to a sponsor, a location associated with a bidder and/or a content element, and/or a ranking of bidders. The sponsor (or sponsors) can be assigned to the tag. For example, information regarding the content element can be determined by the sponsor. As used herein, the term “sponsor” is intended to relate to an entity that is capable of being associated with a tag and/or is capable of associating information with a tag (e.g., is capable of contributing information to an associated tag), and so forth. In one example, a sponsor can be a bidder for the content element. In another example, a sponsor can be a preferred vendor for the content element. In yet another example, a sponsor can be an exclusive sponsor for the content element.

In one embodiment, a content element can include a plurality of sponsors. As such, information associated with a tag can be based on a ranking (e.g., a hierarchy) of the plurality of sponsors. A sponsor with a highest ranking can have greater influence over the information assigned to a content element. For example, a sponsor that places a highest bid (e.g., pays the highest amount of money) can be considered a sponsor with the highest ranking (e.g., a highest ranked sponsor). Therefore, a sponsor with the highest ranking can have greater influence over a detailed description assigned to a content element, can exclusively provide an opportunity to purchase the content element, etc. In another example, a predetermined sponsor (e.g., an accredited vendor, a sponsor with a contract, etc.) can be considered a sponsor with the highest ranking.

The information assigned to the content element can determine how a user (e.g., a user using a content playback viewer, a content consumer, etc.) can interact with the content element. For example, the information assigned to the content element can include a detailed description of the content element (e.g., a textual description of the content element). In one example, the information assigned to the content element can include an opportunity to purchase the content element (e.g., a URL link to a website and/or a phone number of a vendor that sells the content element). In another example, the information assigned to the content element can include an opportunity to purchase the content element (e.g., pricing of the content element, a list of vendors that sells the content element, a coupon or coupon code for a discount on the content element, etc.).

In one non-limiting example, a tag can be assigned to a product or good. A particular entity can be considered a highest bidder (e.g., by placing a highest bid). Therefore, the particular entity can be a sponsor for the tag. Therefore, the particular entity can determine (e.g., control and/or manage) information (e.g., content) provided to a content consumer in response to the content consumer activating the tag associated with the product or good.

In another non-limiting example, a tag can be assigned to a soft drink (e.g., a content element) shown during playback of a media item. A particular company (e.g., a corporation that sells the soft drink) can be assigned as the sponsor for the content element associated with the soft drink. Therefore, the particular sponsor can provide an opportunity to purchase the soft drink to a content consumer that activates the tag assigned to the soft drink. In another example, the particular sponsor can provide a coupon (e.g., a discount, a discount code, etc.) for the soft drink in response to a content consumer activating the tag assigned to the soft drink. Additionally or alternatively, the particular sponsor can provide an advertisement in response to a content consumer activating the tag assigned to the soft drink.

The presentation component 106 can present the tag and/or information regarding the content element. The presentation component 106 can present the tag and/or the information regarding the content element during playback of the media item. For example, the tag can be presented to a user device (e.g., a user device of a content consumer) during playback of the media item on the user device. The tag can be activated during playback of the media item on the user device. As such, information regarding the content element (e.g., information associated with the tag) can be presented on the user device. The information regarding the content element can be determined by the sponsor. In one embodiment, a tag (or information associated with a tag) can be presented for the content element in response to a determination that a sponsor is associated with the tag. For example, only tags that are associated with a sponsor can be presented to a content consumer.

The presentation component 106 can allow a user (e.g., a content consumer) to retrieve (e.g., activate, click, push, etc.) a tag and/or information for a content element. In one example, a tag can be activated by clicking a content element associated with the tag during playback of a media item. In another example, a tag can be activated by clicking on an item associated with the tag during playback of a media item. The type of information presented to a user can depend on the information assigned to the content element. For example, a sponsor (or sponsors) associated with the tag can determine the type of information presented to a user. The presentation component 106 can provide the information to a user device (e.g., a playback device). For example, a user device (e.g., a playback device) can include a desktop computer, a laptop computer, an interactive television, an internet-connected television, a streaming media device, a smartphone, a tablet, a personal computer (PC), a gaming device, etc. In one example, the user device (e.g., the playback device) can be different than a device that displays the media item. For example, the user device (e.g., the playback device) can be a smartphone that displays one or more tags and/or information corresponding to the one or more tags, and playback of the media item can be displayed on a television.

In one embodiment, the presentation component 106 can present one or more prompts to a user device (e.g., a playback device) with one or more tags and/or corresponding information associated with a particular tag. The presentation component 106 can be configured to present a prompt at a user device as a function of the display requirements of the user device and/or the configuration or layout of a screen with a media player for the media item. In an aspect, the presentation component 106 can be configured to determine the display requirements of a user device, such as screen size and/or configuration. In addition, in an aspect, the presentation component 106 can determine the layout and/or configuration of a screen with a media player for the media item. In another example, the presentation component 106 can be configured to determine areas on a screen of a user to device that can present tags and/or information associated with tags. In turn, the presentation component 106 can be configured to present a prompt with a size, shape, and/or orientation, which fits the display requirement of a user device and accommodate the size, shape, and/or configuration of tags and/or information associated with tags. For example, the presentation component 106 can display a prompt with tags and/or information associated with tags in an area associated with a blank space (e.g., an area that does not contain text and/or images) on a screen of a user device.

A data store 112 can store one or more tags and/or associated information for content element(s). It should be appreciated that the data store 112 can be implemented external from the system 100 or internal to the system 100. It should also be appreciated that the data store 112 can be implemented external from a component that includes the tagging component 102, the bidding component 104 and/or the presentation component 106. It should also be appreciated that the data store 112 can alternatively be internal to the tagging component 102, the bidding component 104 and/or the presentation component 106. In an aspect, the data store 112 can be centralized, either remotely or locally cached, or distributed, potentially across multiple devices and/or schemas. Furthermore, the data store 112 can be embodied as substantially any type of memory, including but not limited to volatile or non-volatile, solid state, sequential access, structured access, random access and so on.

While FIG. 1 depicts separate components in system 100, it is to be appreciated that the components may be implemented in a common component. In one example, the tagging component 102, the bidding component 104 and/or the presentation component 106 can be included in a single component. Further, it can be appreciated that the design of system 100 can include other component selections, component placements, etc., to control and/or manage tagged data for media content.

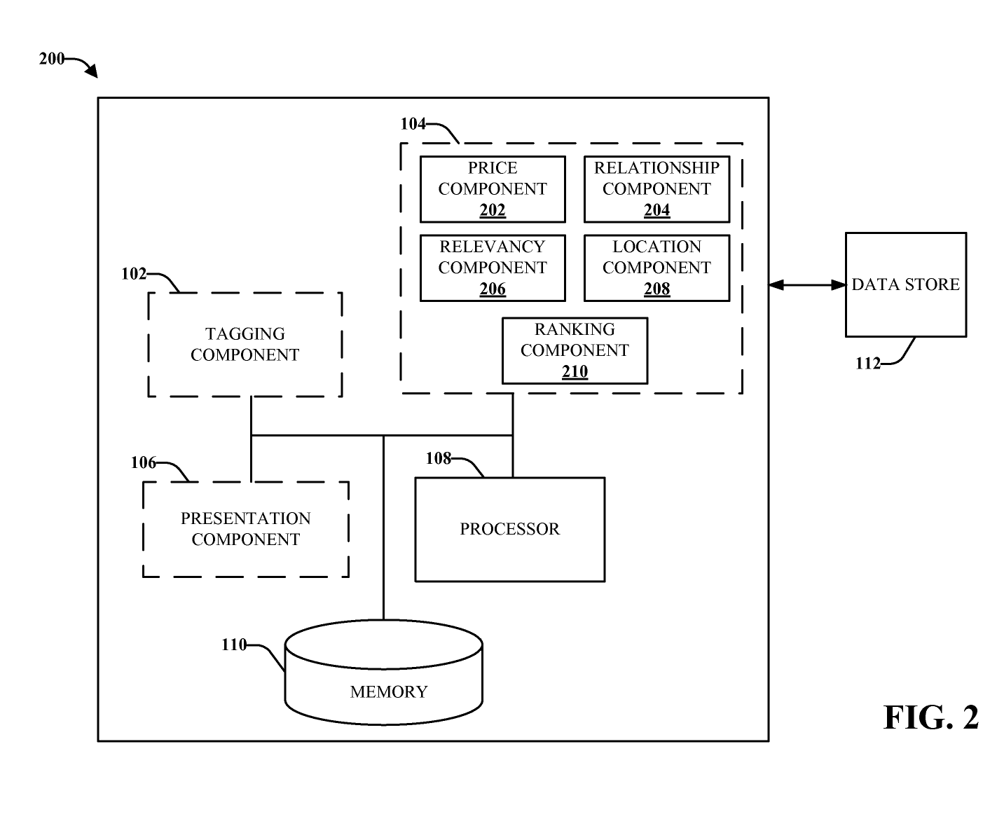

Referring now to FIG. 2, there is illustrated a non-limiting implementation of a system 200 in accordance with various aspects and implementations of this disclosure. The system 200 includes the tagging component 102, the bidding component 104 and the presentation component 106. The bidding component 104 includes a price component 202, a relationship component 204, a relevancy component 206, a location component 208 and a ranking component 210.

The price component 202 can be configured to determine control and/or management of information associated with a tag based at least in part on monetary payment. The price component 202 can select a sponsor from one or more bidders based at least in part on monetary payment. In one example, a bidder that pays the highest monetary payment can become a sponsor for a tagged content element. In another example, the price component 202 can set a fee to add information associated with a tag. Therefore, a tag can be associated with and/or can include information from more than one sponsor (e.g., more than one contributor). In one example, different sponsors (e.g., different contributors) can contribute different amounts of information associated with a tag based on an amount of a monetary payment. For example, a sponsor that pays a higher fee can contribute more information. In another example, information provided by a sponsor that pays a higher fee can be presented to a content consumer in a more desirable manner (e.g., before information provided by sponsors that pay a lower fee). As such, one or more bidders can bid for placement of a tag (e.g., how a tag is presented in regards to other tags, placement of a tag next on a screen next to a media item, etc.) Furthermore, one or more bidders can bid for placement of information associated with a tag (e.g., placement of information in regards to other information).

Additionally or alternatively, the price component 202 can set an amount and/or type of information provided by a sponsor based on monetary payment. For example, a sponsor that pays more can provide more information regarding a content element. In another example, a sponsor is permitted to provide detailed information regarding a content element, an opportunity to purchase a content element and/or a URL link associated with a content element based on monetary payment.

In one embodiment, the price component 202 can determine a sponsor of a tag for a particular scene of a media item based on monetary payment. For example, a tag can include different sponsors for different scenes of a media item. As such, different scenes of a media item can include different sponsors for the same tag based on, for example, monetary payment.

The relationship component 204 can be configured to determine control and/or management of information associated with a tag based at least in part on a determined relationship. For example, a determined relationship can be a determined relationship between a sponsor (or a content consumer) and a content element. In another example, a determined relationship can be a determined relationship between a sponsor (or a content consumer) and a media item. However, it is to be appreciated that determined relationship can be a different relationship between a content element, a tag, a media item, a bidder, a sponsor, a content consumer, a content viewer and/or a content provider. The relationship component 204 can determine a set of bidders (e.g., potential sponsors) for a particular tag based on a relationship associated with the content element. For example, the relationship component 204 can restrict bidders for a particular tag to accredited vendors. For example, a particular movie studio can restrict bidders of a tag (e.g., a tag associated with a content element in a media item of the particular movie studio) to vendors that are accredited with the particular movie studio. In another example, the relationship component 204 can assign a sponsor to tag without considering bids for the tag. For example, a company that sells a particular product or good associated with a tag can be considered the sponsor for the tag (e.g., an exclusive sponsor for the tag). Therefore, a tag can include a predetermined sponsor.

In one embodiment, the relationship component 204 can be configured to allow a subset of content consumers to contribute information to a tag. In one example, a content consumer that purchased a media item (e.g., purchased a movie, rented a movie, etc.) can contribute information to one or more tags of the media item.

The relevancy component 206 can be configured to determine control and/or management of information associated with a tag based at least in part on a determined relevancy. The relevancy component 206 can determine a set of bidders (e.g., potential sponsors) for a particular tag based on relevancy. The relevancy component 206 can select a sponsor from one or more bidders based at least in part on relevancy of a tag (e.g., a content element) to a sponsor. For example, a particular vendor that sells a content element can be considered a more relevant sponsor than another vendor that sells a content element (e.g., based on reputation, product availability and/or stock, etc.). In one example, a hotel or restaurant in the same city as a filmed scene can be considered a relevant bidder (e.g., a potential sponsor) for a tag (or be allowed to add information for a tag). However, it is to be appreciated that relevancy can be determined based on, for example, a content element, a tag, a media item, a bidder, a sponsor, a content consumer, a content viewer and/or a content provider.

In one embodiment, the relevancy component 206 can determine whether a content element is relevant to the media content. In one example, a content element used and/or associated with a main actor (or main actors) in a media item (e.g., clothing worn by the main actor, cars driven by the main actor, products or goods used by the main actor, etc.) can be considered a relevant content element. As such, relevant content elements can be biddable implemented as content elements.

The relevancy component 206 can tag a content element based at least in part on relevancy of a keyword associated with the content element. In one example, a content element is tagged based on a relevancy factor (e.g., a popularity factor, an interest level, etc.). For example, the relevancy component 206 can determine relevancy of a content element (e.g., a keyword associate with a content element) based on trend analysis. For example, the relevancy component 206 can determine whether a keyword associated with a content element is relevant by obtaining trend analysis information from social media sites, search engines sites, etc. Therefore, if a keyword associated with a content element is mentioned a certain amount of times on one or more social media sites or is searched for a certain amount of times via one or more search engines, then a content element can be considered a biddable content element. In one example, the relevancy component 206 can determine relevancy of a content element in real-time (e.g., using real-time trend statistics). Therefore, the presentation component 106 can determine which tags to present based at least in part on real-time relevancy data provided by the relevancy component 206. In another example, the presentation component 106 can determine which tags to present based on relevancy data provided by the relevancy component 206 over a predetermined time period (e.g., relevancy of a content element over a previous month period, etc.).

The location component 208 can select bidders for a particular tag based on a location of the bidders. For example, location information assigned to a content element (e.g., a geographic location, a hotel, a restaurant, a retail store, etc.) can be used to select bidders for the content element. In one example, the location component 208 can restrict bidding to bidders in a particular geographic location (e.g., a particular country, city, region, etc.). In another example, a particular tag can include different information based on location of content consumers (e.g., viewers). For example, a tag presented in one geographic region can include certain information and the same tag presented in another geographic region can include different information. In one example, a sponsor for a tag in a certain geographic location can be different than a sponsor for the tag in a different geographic location. In one example, a retail store can bid for rights in a particular geographic location (e.g., a particular city, region, country, etc.). As such, location can determine sponsorship of a tag.

The ranking component 210 can determine a ranking of bidders for a tag. For example, criteria set by the price component 202, the relationship component 204, the relevancy component 206 and/or the location component 208 can influence selection of a sponsor. For example, a content provider (e.g., a content operator) can determine an amount of influence set by the price component 202, the relationship component 204, the relevancy component 206 and/or the location component 208 for determining a sponsor. In one example, price (e.g., monetary payment) can influence selection of a sponsor more than a determined relationship, a determined relevancy or determined location. In another example, a determined relationship can influence selection of sponsor more than price, relevancy or location. The ranking component 210 can set different percentages of influence (e.g., different levels of influence, different weights, etc.) for each criterion. As such, the bidding component 104 can determine a sponsor based on monetary payment, a determined relationship, a determined relevancy and/or a determined location (e.g., different criteria can have different levels of influence for determining sponsorship of a tag).

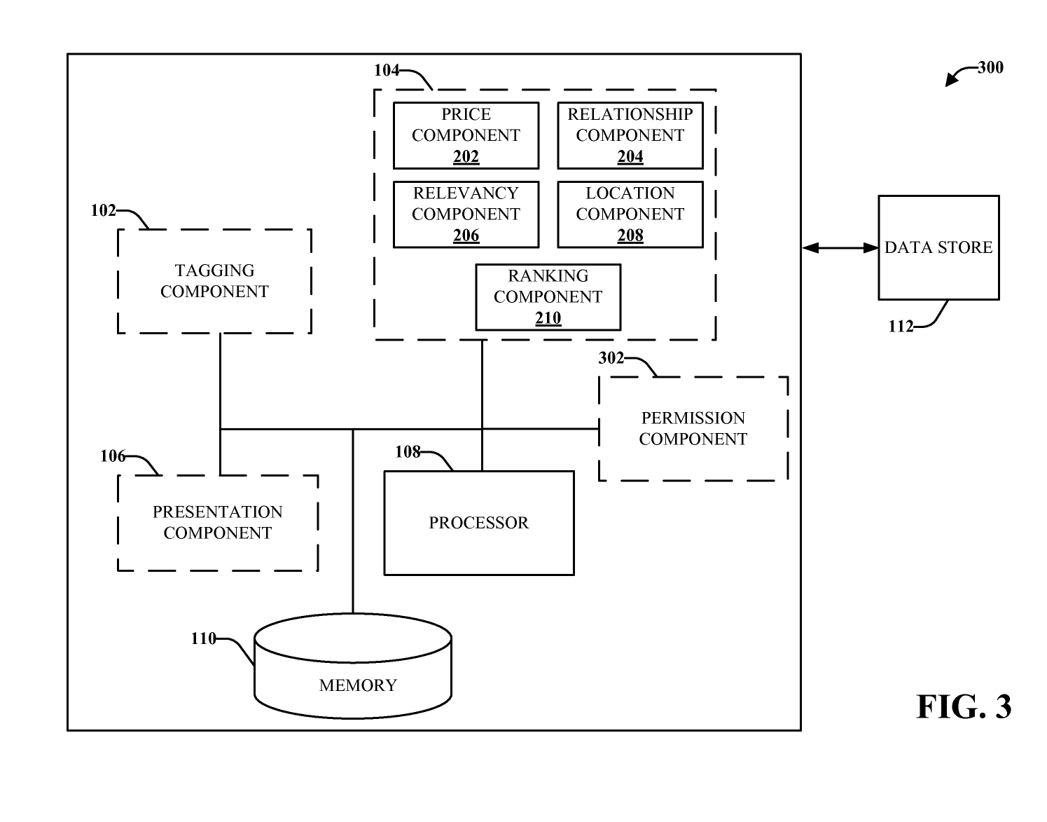

Referring now to FIG. 3, there is illustrated a non-limiting implementation of a system 300 in accordance with various aspects and implementations of this disclosure. The system 300 includes the tagging component 102, the bidding component 104, the presentation component 106 and a permission component 302.

The permission component 302 can set presentation rights and/or sharing rights for a particular tag. In one example, the permission component 302 can receive data from the bidding component 104. For example, the permission component 302 can receive data from the price component 202, the relationship component 204, the relevancy component 206 and/or the location component 208. The permission component 302 can determine a criterion (or criteria) for presenting a particular tag (e.g., set presenting rights). For example, the permission component 302 can present a tag based on a geographic location. In one example, viewers in a particular geographic location can receive a particular tag and other viewers in a different geographic location can receive a different tag (and/or not receive the particular tag).

In one embodiment, the permission component 302 can set presentation rights and/or sharing rights based on location (e.g., a geographic location). For example, a content consumer (e.g., a viewer) in a particular city can be permitted to share with other content consumers (e.g., viewers) in the particular city (or a region that includes the particular city), but not with other content consumers (e.g., viewers) in a different city (or a different region).

Additionally or alternatively, the permission component 302 can set sharing rights for sharing the information regarding the content element (e.g., limitations regarding how and/or when a tag can be shared). For example, a content provider (e.g., content operator, content owner, etc.) can set sharing rights for sharing information regarding the content element. In one example, if information added by a particular content consumer relates to a rating of a content element, the information can be presented without limitations (e.g., any content consumer can view the information). However, if the information added by a particular content consumer is, for example, a comment (e.g., a comment related to a content element), then the information can be hidden from all viewers except a circle of friends (or a subset thereof) of the content consumer. Therefore, information can be limited to a select group of content consumer (e.g., viewers).

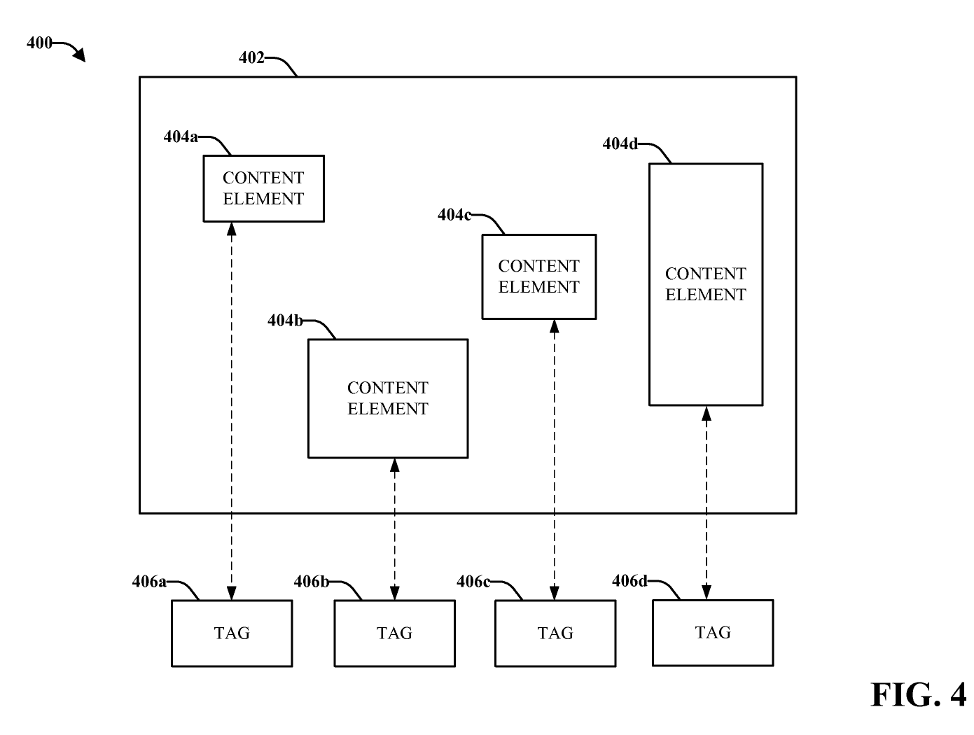

Referring now to FIG. 4, there is illustrated a non-limiting implementation of a system 400 in accordance with various aspects and implementations of this disclosure. The system 400 includes a media item 402. The media item 402 can include one or more content elements 404. In the example shown in FIG. 4, the media item 402 includes a content element 404a, a content element 404b, a content element 404c and a content element 404d. However, it is to be appreciated that a media item can include any number of content elements. The content elements 404a-d can each be assigned a tag. For example, the content element 404a can be assigned to a tag 406a, the content element 404b can be assigned to a tag 406b, the content element 404c can be assigned to a tag 406c and the content element 404d can be assigned to a tag 406d. The tags 406a-d can be assigned to a sponsor. For example, the tag 406a can be assigned to a first sponsor, the tag 406b can be assigned to a second sponsor, the tag 406c can be assigned to a third sponsor and the tag 406d can be assigned to a fourth sponsor. The sponsors can determine the type of information associated with the tags 406a-d (e.g., presented by activating a particular one of the tags 406a-d). For example, the first sponsor can determine the type of information associated with the tag 406a (e.g., presented by activating the tag 406a).

In a non-limiting example, the content element 404a can be a location, the content element 404b can be a product or good, the content element 404c can be a garment and the content element 404d can be an actor. As such, the tag 406a associated with the content element 404a (e.g., the location) can be, for example, a name of a city. A sponsor for the tag 406a can include, for example, places (e.g., hotels, restaurants, places of interest, attractions, etc) at the location. The tag 406b associated with the content element 404b (e.g., the product or good) can be, for example, a name of the product or good. A sponsor for the tag 406b can include, for example, a company or vendor that sells the product or good. The tag 406c associated with the content element 404c (e.g., the garment) can be, for example, a name of the garment. A sponsor for the tag 406c can include, for example, a company or retail store that sells the garment. The tag 406d associated with the content element 404d (e.g., the actor) can be, for example, a name of the actor. A sponsor for the tag 406d can include, for example, a film production company that created the media content with the actor. However, in another example, the tag 406d can be implemented without a sponsor (e.g., any content consumer can add information associated with the tag 406d).

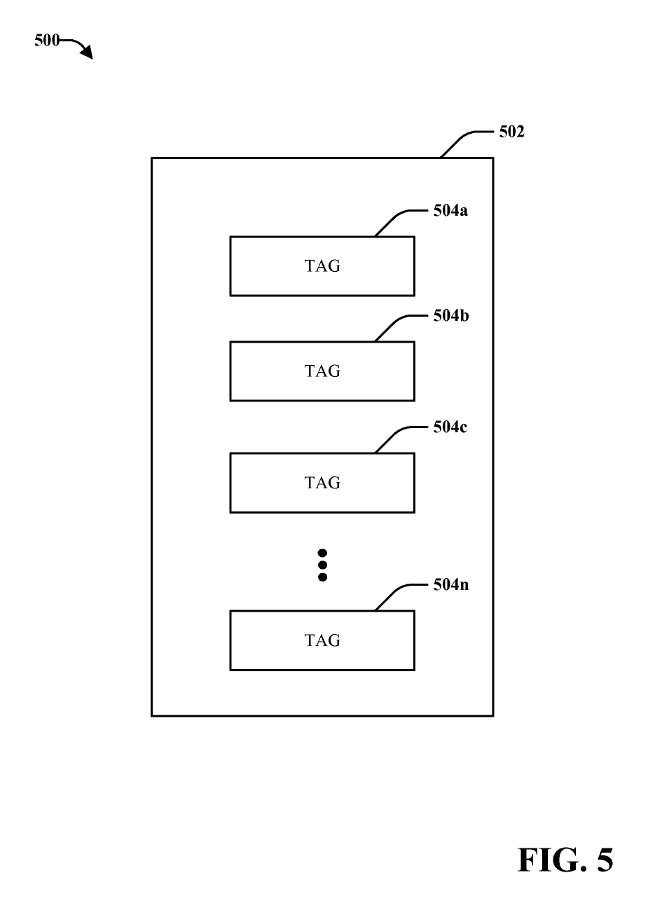

Referring now to FIG. 5, there is illustrated a non-limiting implementation of a system 500 in accordance with various aspects and implementations of this disclosure. The system 500 includes a screen 502 and one or more tags 504a-n. Each of the tags 504a-n can be associated with a particular content element in a media item.

The tags 504a-n can be presented on one or more user devices (e.g., one or more client devices, one or more playback devices, etc.). In one example, the tags 504a-n can be presented in connection with a media service. A user device can include any computing device generally associated with a user and capable of playing a media item and interacting with media content (e.g., a video, a media service, etc.). For example, a user device can include a desktop computer, a laptop computer, an interactive television, a smartphone, a gaming device, or a tablet personal computer (PC). As used herein, the term user refers to a person, entity, or system that utilizes a user device and/or utilizes media content (e.g., employs a media service). The tags 504a-n can be activated during playback of a media item (e.g., by clicking on a content element associated with a particular one of the tags 504a-n). In one example, the tags 504a-n can be presented, for example, on a prompt associated with a media item. In one embodiment, a user device is configured to access a media service via a network such as the Internet or an intranet. In another embodiment, a media service is integral to a user device. For example, a user device can include a media service.

In an aspect, a user device interfaces with media service via an interactive web page. For example a page, such as a hypertext mark-up language (HTML) page, can be displayed at a user device and is programmed to be responsive to a the playing of a media item at the user device. It is noted that although the embodiments and examples will be illustrated with respect to an architecture employing HTML pages and the World Wide Web, the embodiments and examples may be practiced or otherwise implemented with any network architecture utilizing clients and servers, and with distributed architectures, such as but not limited to peer to peer systems.

In an embodiment, the media service can include an entity such as a world wide web, or Internet, website configured to provide media items. According to his embodiment, a user can employ a user device to view or play a media item as it is streaming from the cloud over a network from the media service. For example, media service can include a streaming media provider, or a website affiliated with a broadcasting network. In another embodiment, media service can be affiliated with a media provider, such as an Internet media provider or a television broadcasting network. According to this embodiment, the media provider can provide media items to a user device and employ media service to present prompts to the user device associated with the media items. Still in yet another embodiment, a user device can include a media service to monitor media items received from external sources or stored and played locally at the user device.

In one example, the screen 502 can be implemented on a user device that plays the media content associated with the one or more tags 504a-n. For example, during playback of media content, the one or more tags 504a-n can be activated. In one example, the one or more tags 504a-n can be displayed along side a video player that plays the media content. In one embodiment, the screen 502 can be implemented as a second screen. For example, a video player that plays the media content can be implemented on a first user device (e.g., a television) and the one or more tags 504a-n can be activated via a second user device (e.g., a smartphone). In one example, placement of the one or more tags 504a-n (e.g., presentation of the one or more tags 504a-n) can be determined by the ranking component 210.

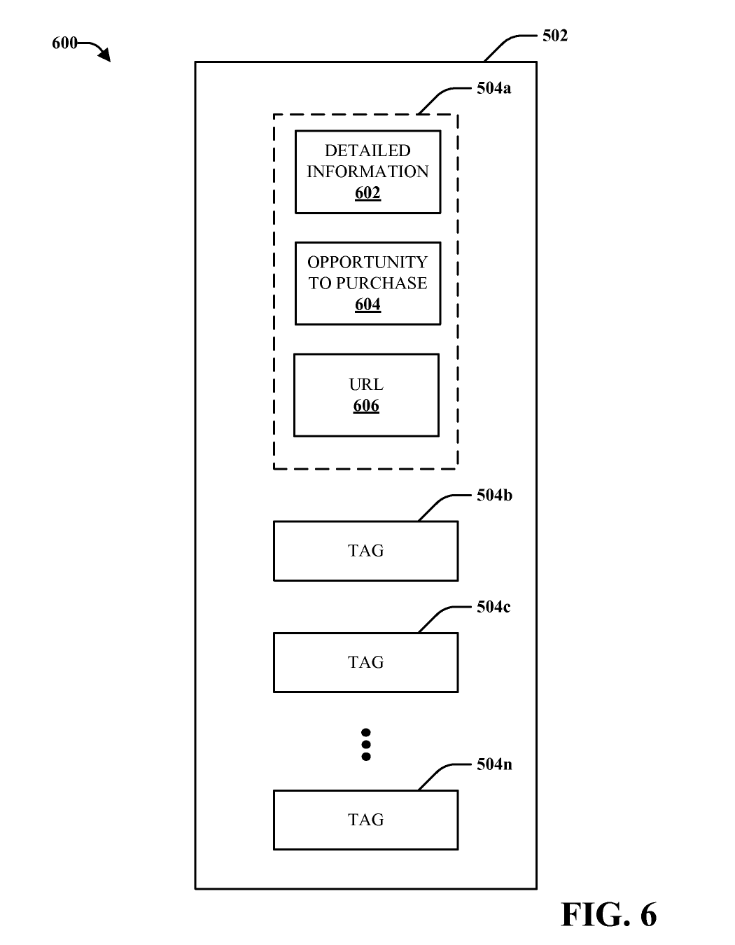

Referring now to FIG. 6, there is illustrated a non-limiting implementation of a system 600 in accordance with various aspects and implementations of this disclosure. The tag 504a includes and/or is associated with detailed information 602, an opportunity to purchase 604 and/or a URL 606. For example, the tag 504a can be associated with a product or good. Therefore, the detailed information 602 can include detailed information regarding the product or good. Furthermore, the opportunity to purchase 604 can include an opportunity to purchase the product or good (e.g., a name of a vendor for the product or good, a coupon or coupon code for the product or good, pricing for the product or good, etc.). In addition, the URL 606 can provide a URL link associated with the product or good (e.g., a URL link to a webpage that includes detailed information, ratings and/or reviews for the product or good, a URL link for a website of a vendor for the product or good, a URL link to a website that includes a coupon for the product or good, etc.).

The detailed information 602, the opportunity to purchase 604 and/or the URL 606 can be provided by a sponsor. For example, a sponsor can exclusively provide the detailed information 602, the opportunity to purchase 604 and/or the URL 606. In another example, more than one sponsor can provide the detailed information 602, the opportunity to purchase 604 and/or the URL 606.

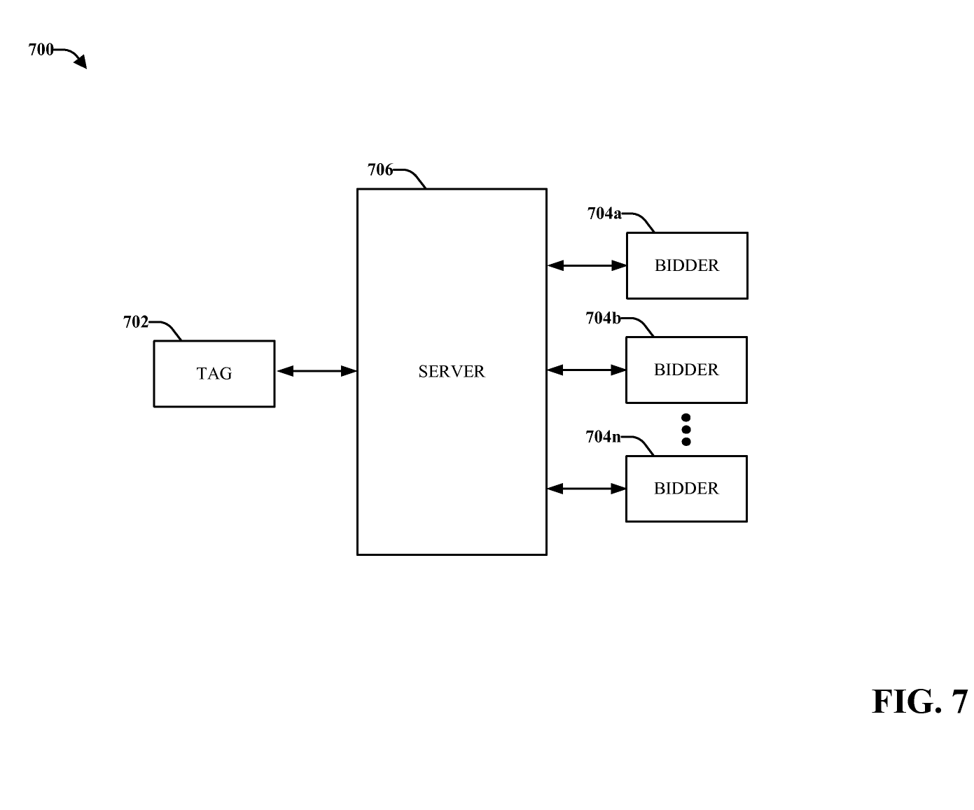

Referring to FIG. 7, there is illustrated a non-limiting implementation of a system 700 in accordance with various aspects and implementations of this disclosure. The system 700 includes a tag 702 and one or more bidders 704a-n. The bidders 704a-n can bid on the tag 702. The bidder 704a-n that becomes a highest bidder can be considered a sponsor for the tag 702. Therefore, a highest bidder (e.g., the sponsor) can determine the type of information associated with the tag 702.

The system 100 can be implemented, for example, on the server 706. The server 706 can be implemented as a central server. The one or more bidders 704a-n can be electronically linked via the server 706. The tag can be associated with the server 706, for example, via a data store. The server 706 can be configured to provide a convenient forum (e.g., a website, a program, an application, etc.) in which the bidders 704a-n can bid for the tag 702 (e.g., bid to be a sponsor and/or add information in connection with the tag 702). The forum can, for example, be an established Internet web page where the bidders 704a-n can bid for the tag 702.

Each of the bidders 704a-n can access the server 706 in any of a variety of ways. For example, bidders 704a-n are shown to be part of separate user devices. Therefore, each of the bidders 704a-n can bid for the tag 702 via different types of user devices, such as but not limited to, a desktop computer, a laptop computer, a cell phone, a smartphone, a tablet, a personal computer (PC), an interactive television, an interactive media device, etc. It will be appreciated that the bidders 704a-n can interact with the sever 706 via wired or wireless systems, by local networks or widely distributed networks, etc. Further, it will be appreciated, that while bidders 704a-n are shown to communicate with the server 706 via different user devices, it will be appreciated that the one or more of the bidders 704a-n can access the server 706 from the same user device.

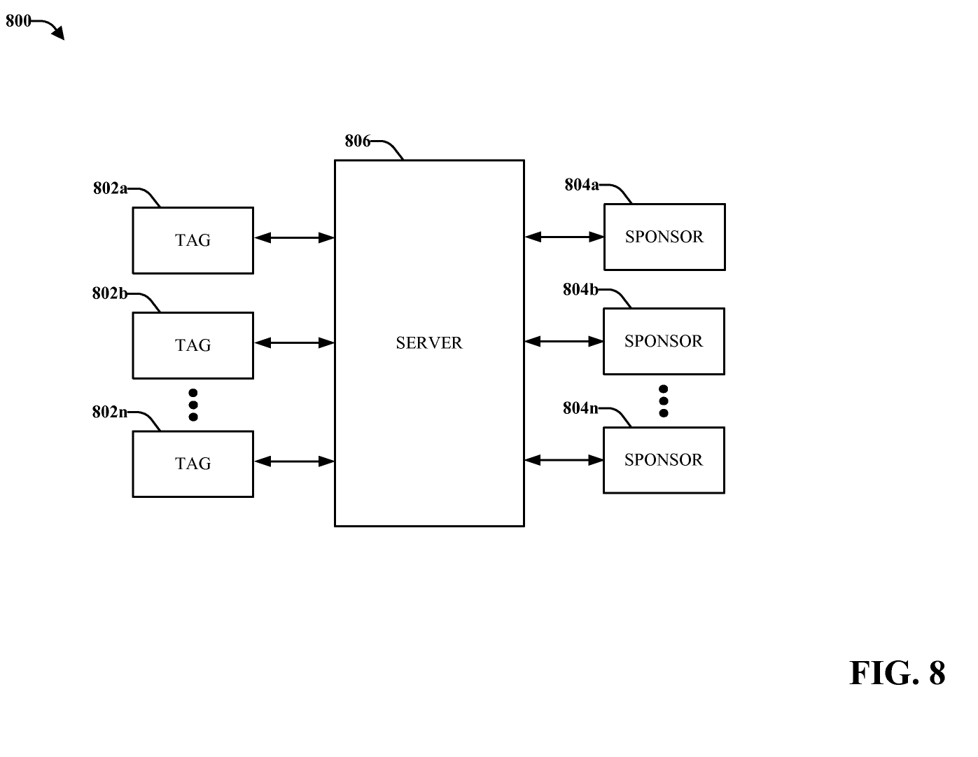

Referring now to FIG. 8, there is illustrated a non-limiting implementation of a system 800 in accordance with various aspects and implementations of this disclosure. The system 800 includes one or more tags 802a-n and one or more sponsors 804a-n. Each of the one or more sponsors can be a sponsor for one or more of the tags 802a-n. Therefore, each of the one or more sponsors can determine the type of information associated with one or more of the tags 802a-n.

The system 100 can be implemented, for example, on the server 806. The server 806 can be implemented as a central server. The one or more sponsors 804a-n can be electronically linked via the server 806. The one or more tags 802a-n can be associated with the server 806, for example, via a data store. The server 806 can be configured to provide a convenient forum (e.g., a website, a program, an application, etc.) in which the sponsors 804a-n can add information associated with one or more of the tags 802a-n. The forum can, for example, be an established Internet web page where the sponsors 804a-n can add information associated with one or more of the tags 802a-n.

Each of the sponsors 804a-n can access the server 806 in any of a variety of ways. For example, sponsors 804a-n are shown to be part of separate user devices. Therefore, each of the sponsors 804a-n can add information to one or more of the tags 802a-n via different types of user devices, such as but not limited to, a desktop computer, a laptop computer, a cell phone, a smartphone, a tablet, a personal computer (PC), an interactive television, an interactive media device, etc. It will be appreciated that the sponsors 804a-n can interact with the sever 806 via wired or wireless systems, by local networks or widely distributed networks, etc. Further, it will be appreciated, that while sponsors 804a-n are shown to communicate with the server 806 via different user devices, it will be appreciated that the one or more of the sponsors 804a-n can access the server 806 from the same user device.

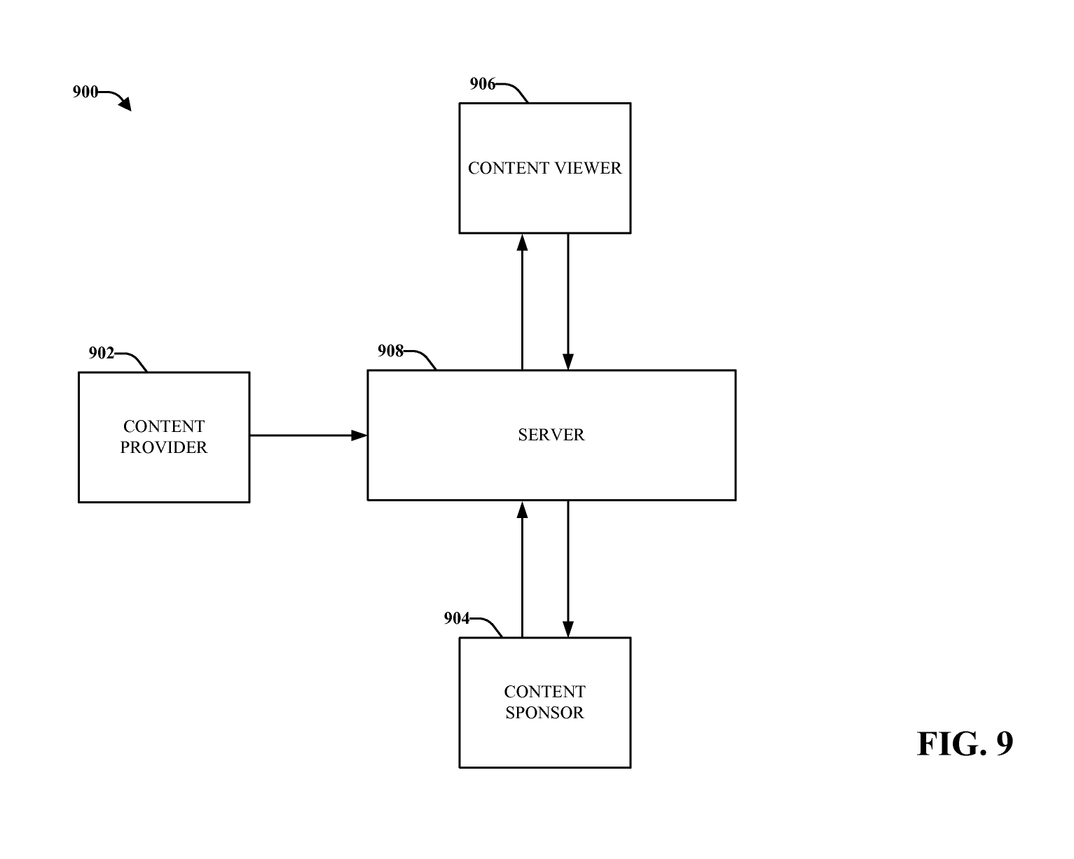

Referring to FIG. 9, there is illustrated a non-limiting implementation of a system 900 in accordance with various aspects and implementations of this disclosure. The system 900 includes a content provider (or content providers) 902, a content sponsor (or content sponsors) 904, a content viewer (or content viewers) 906 and a server 908. The content provider 902, the content sponsor 904 and the content viewer 906 can be associated with a user device, such as but not limited to, a desktop computer, a laptop computer, a cell phone, a smartphone, a tablet, a personal computer (PC), an interactive television, an interactive media device, etc. The system 100 can be implemented, for example, on the server 908.

The content provider 902 can identify and/or auto-recognize (e.g., implement auto-recognition to identify) one or more content elements in a media item. Additionally, the content provider 902 can tag one or more content elements in a media item. Furthermore, the content provider 902 can assign a detailed description and/or keywords to one or more content element (e.g., one or more tags) in a media item.

The content sponsor 904 can receive one or more tags associated with one or more content elements. Therefore, the content sponsor 904 can interact with one or more tags (e.g., control and/or manage information associated with one or more tags). Furthermore, the content sponsor 904 can publish keywords (e.g., identify content elements). The content sponsor 904 can also assign tag values to identified content elements. Additionally, the content sponsor 904 can set permissions (e.g., presentation rights and/or sharing rights) to access and/or control the one or more tags.

The content viewer 906 can select (e.g., interact, activate, etc.) one or more tags (e.g., one or more content elements) in a media item (e.g., during playback of a media item). Furthermore, the content viewer 906 can obtain information associated with one or more tags (e.g., detailed information regarding one or more content elements, an opportunity to purchase one or more content elements, one or more URL links associated with one or more content elements, etc.). Additionally, the content viewer 906 can comment and/or rate a content element (e.g., a tag).

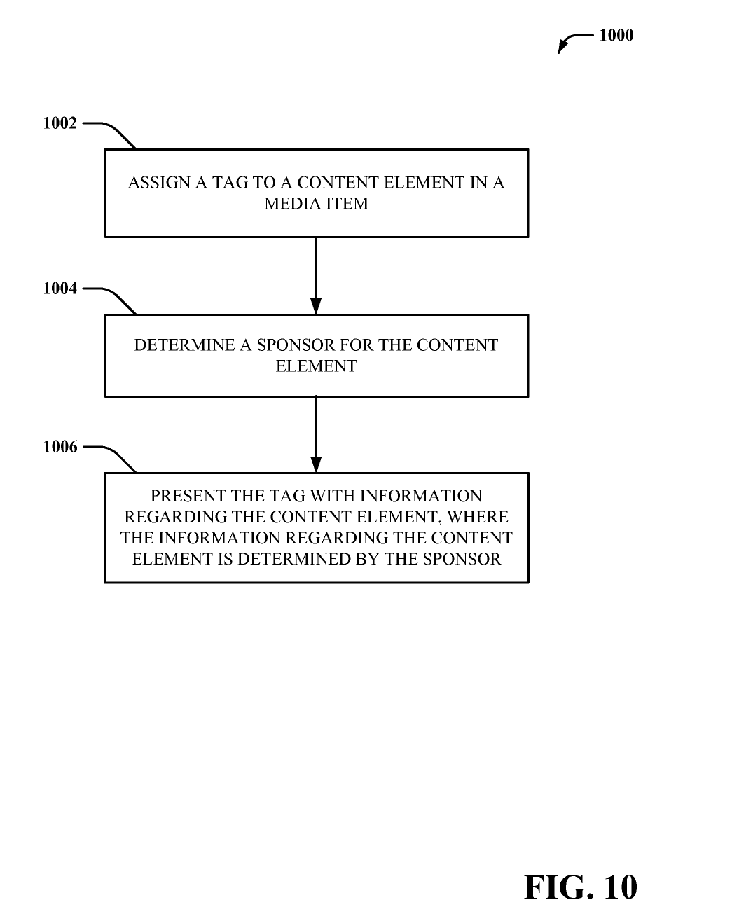

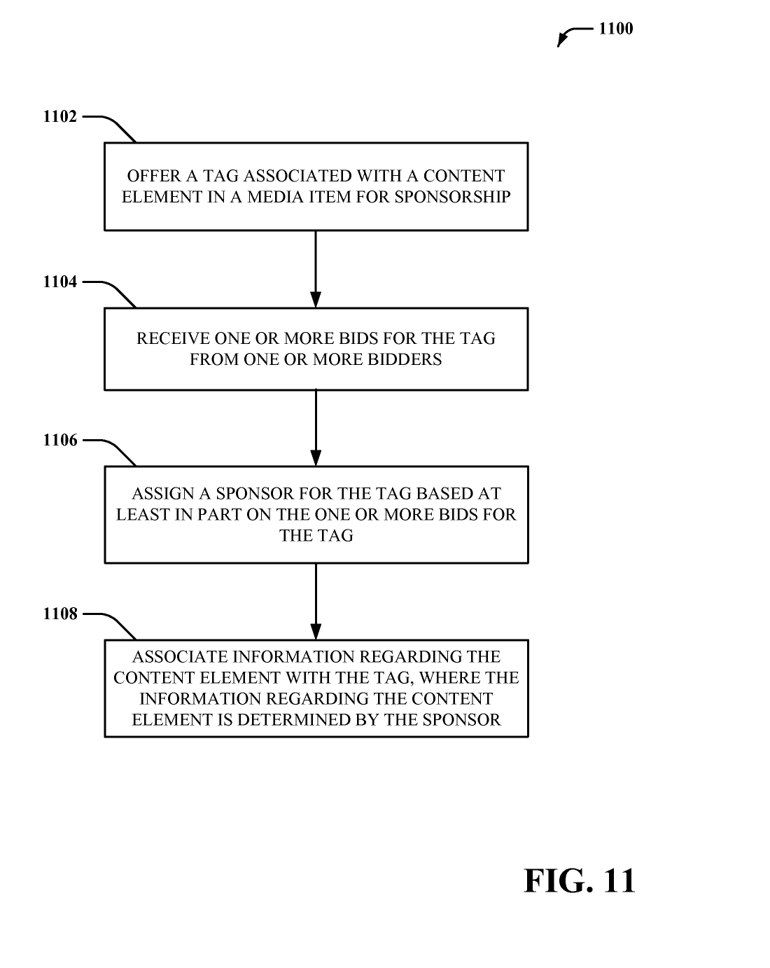

FIGS. 10-11 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers.

Referring now to FIG. 10, presented is an exemplary non-limiting embodiment of a method 1000 for controlling and/or managing tagged data in media content. At 1002, a tag is assigned to a content element in a media item. For example, a tag can be assigned to an object, a product, a good, a device, an item of manufacture, a person, an entity, a geographic location or a place in a media item (e.g., a movie, a live television program, a recorded television program, a streaming video clip, a user-generated video clip, etc.). At 1004, a sponsor for the content element is determined. For example, an entity that can manage and/or control information regarding the content element can be determined (e.g., assigned). At 1006, the tag with information regarding the content element is presented. The information regarding the content element is determined by the sponsor. For example, a tag that can be activated (e.g., by a content consumer) to display information regarding the content element can be presented alongside playback of the media item or on a separate playback device.

Referring now to FIG. 11, presented is an exemplary non-limiting embodiment of a method 1100 for assigning a sponsor to a tag in a media item. At 1102, a tag associated with a content element in a media item is offered for sponsorship. For example, one or more bidders can bid for rights control, manage and/or contribute to the tag. At 1104, one or more bids for the tag are received from one or more bidders. For example, one or more bidders can offer different bids for rights (e.g., control rights, management rights, contribution rights, etc.) to the tag. At 1106, a sponsor for the tag is assigned based at least in part on the one or more bids for the tag. For example, a highest bidder can be assigned to the tag. At 1108, information regarding the content element is associated with the tag. The information regarding the content element is determined by the sponsor. For example, the sponsor can provide a detailed description of the content element, an opportunity to purchase the content element and/or a URL link associated with the content element.

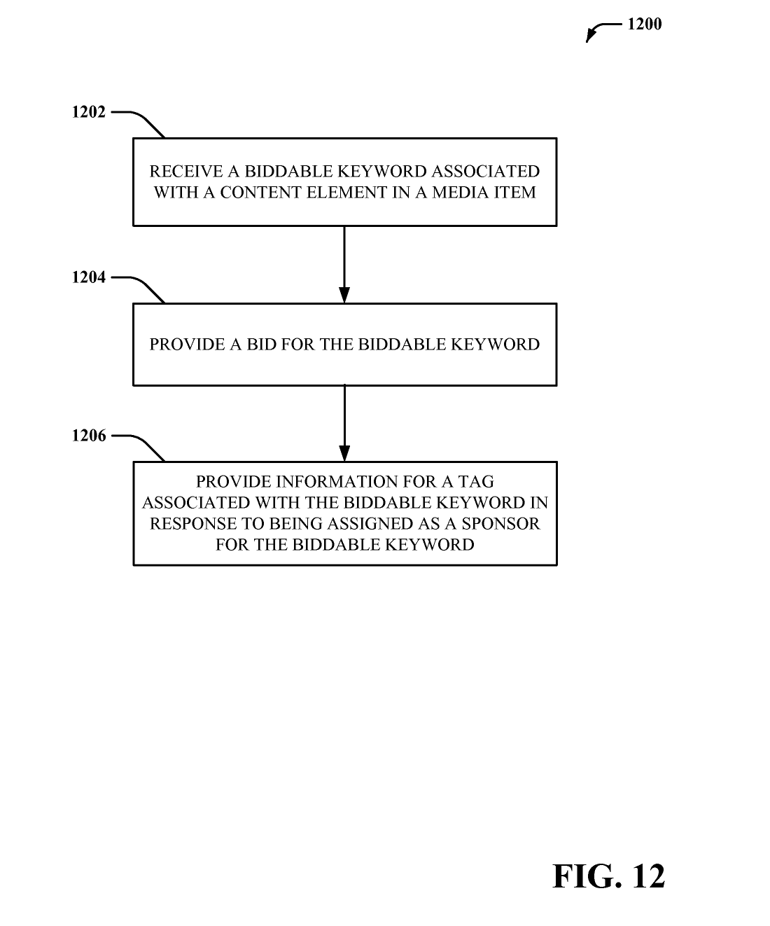

Referring now to FIG. 12, presented is an exemplary non-limiting embodiment of a method 1200 for bidding on a biddable keyword. At 1202, a biddable keyword associated with a content element in a media item is received. For example, a biddable keyword associated with an object, a product, a good, a device, an item of manufacture, a person, an entity, a geographic location or a place in a media item (e.g., a movie, a live television program, a recorded television program, a streaming video clip, a user-generated video clip, etc.) can be received. At 1204, a bid for the biddable keyword is provided. For example, a potential sponsor for the biddable keyword can present a bid for the biddable keyword (e.g., via a user device). At 1206, information for a tag associated with the biddable keyword is provided in response to being assigned as a sponsor for the biddable keyword. For example, a sponsor can provide information (e.g., a detailed description of the content element, an opportunity to purchase the content element, a URL link associated with the content element, etc.) for a tag associated with the biddable keyword.

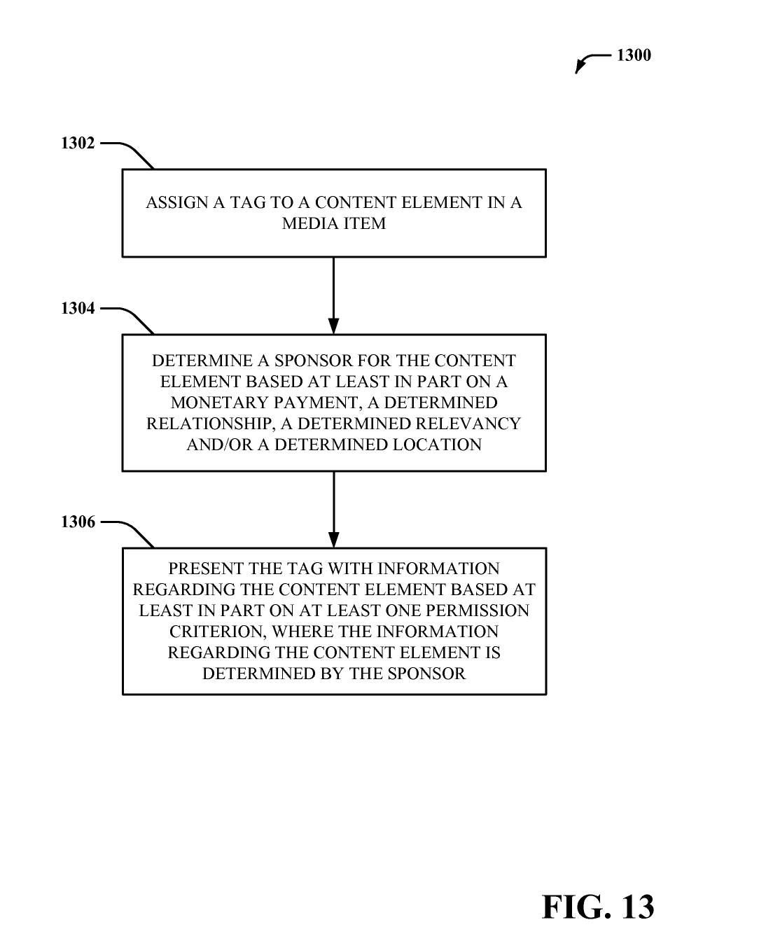

Referring now to FIG. 13, presented is another exemplary non-limiting embodiment of a method 1300 for controlling and/or managing tagged data in media content. At 1302, a tag is assigned to a content element in a media item. For example, a tag can be assigned to an object, a product, a good, a device, an item of manufacture, a person, an entity, a geographic location or a place in a media item (e.g., a movie, a live television program, a recorded television program, a streaming video clip, a user-generated video clip, etc.). At 1304, a sponsor for the content element is determined based at least in part on a monetary payment, a determined relationship, a determined relevancy and/or a determined location. For example, an entity that can manage and/or control information regarding the content element can be determined based at least in part on a monetary payment, a determined relationship, a determined relevancy and/or a determined location. At 1306, the tag with information regarding the content element is presented based at least in part on at least one permission criterion. The information regarding the content element is determined by the sponsor. For example, a tag that can be activated (e.g., by a content consumer) to display information regarding the content element can be presented to a subset of viewers based on at least one permission criterion.

### Example Operating Environments

One of ordinary skill in the art can appreciate that the various non-limiting embodiments of matrix generation and matrix utilization and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the matrix generation and matrix utilization as described for various non-limiting embodiments of the subject disclosure.

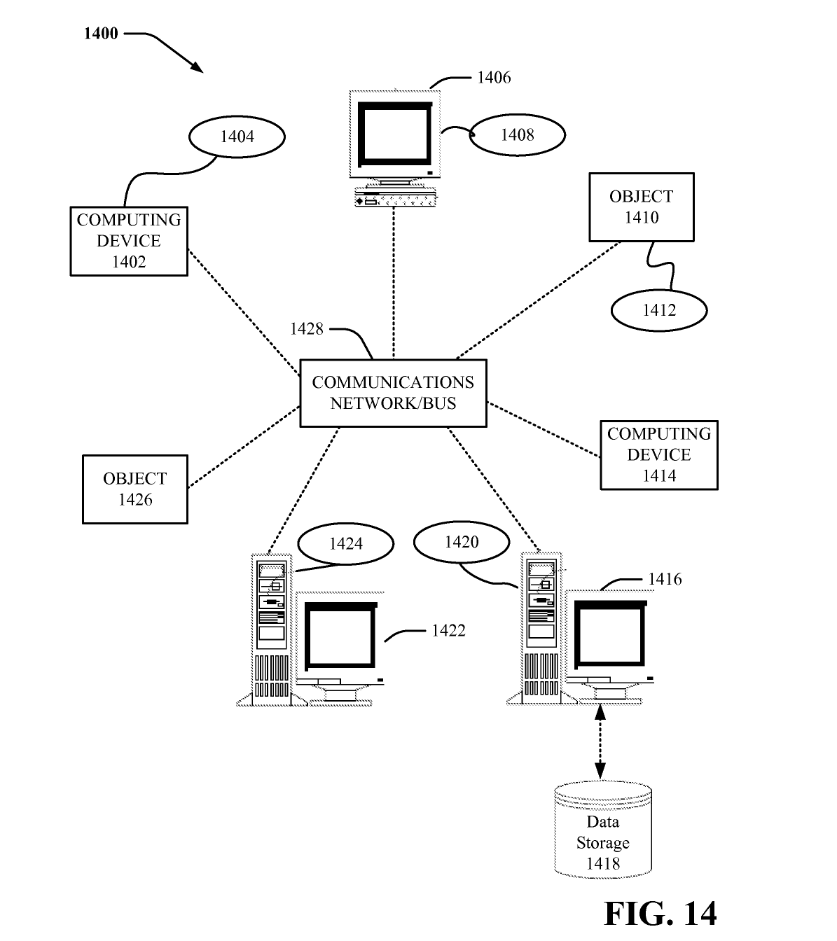

FIG. 14 provides a schematic diagram of an exemplary networked or distributed computing environment. The distributed computing environment comprises computing objects 1422, 1416, etc. and computing objects or devices 1402, 1406, 1410, 1426, 1414, etc., which may include programs, methods, data stores, programmable logic, etc., as represented by applications 1404, 1408, 1412, 1424, 1420. It can be appreciated that computing objects 1422, 1416, etc. and computing objects or devices 1402, 1406, 1410, 1426, 1414, etc. may comprise different devices, such as personal digital assistants (PDAs), audio/video devices, mobile phones, MP3 players, personal computers, laptops, etc.

Each computing object 1422, 1416, etc. and computing objects or devices 1402, 1406, 1410, 1426, 1414, etc. can communicate with one or more other computing objects 1422, 1416, etc. and computing objects or devices 1402, 1406, 1410, 1426, 1414, etc. by way of the communications network 1426, either directly or indirectly. Even though illustrated as a single element in FIG. 14, communications network 1426 may comprise other computing objects and computing devices that provide services to the system of FIG. 14, and/or may represent multiple interconnected networks, which are not shown. Each computing object 1422, 1416, etc. or computing object or device 1402, 1406, 1410, 1426, 1414, etc. can also contain an application, such as applications 1404, 1408, 1412, 1424, 1420, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 14, as a non-limiting example, computing objects or devices 1402, 1406, 1410, 1426, 1414, etc. can be thought of as clients and computing objects 1422, 1416, etc. can be thought of as servers where computing objects 1422, 1416, etc., acting as servers provide data services, such as receiving data from client computing objects or devices 1402, 1406, 1410, 1426, 1414, etc., storing of data, processing of data, transmitting data to client computing objects or devices 1402, 1406, 1410, 1426, 1414, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1426 or bus is the Internet, for example, the computing objects 1422, 1416, etc. can be Web servers with which other computing objects or devices 1402, 1406, 1410, 1426, 1414, etc. communicate via any of a number of known protocols, such as the hypertext transfer protocol (HTTP). Computing objects 1422, 1416, etc. acting as servers may also serve as clients, e.g., computing objects or devices 1402, 1406, 1410, 1426, 1414, etc., as may be characteristic of a distributed computing environment.

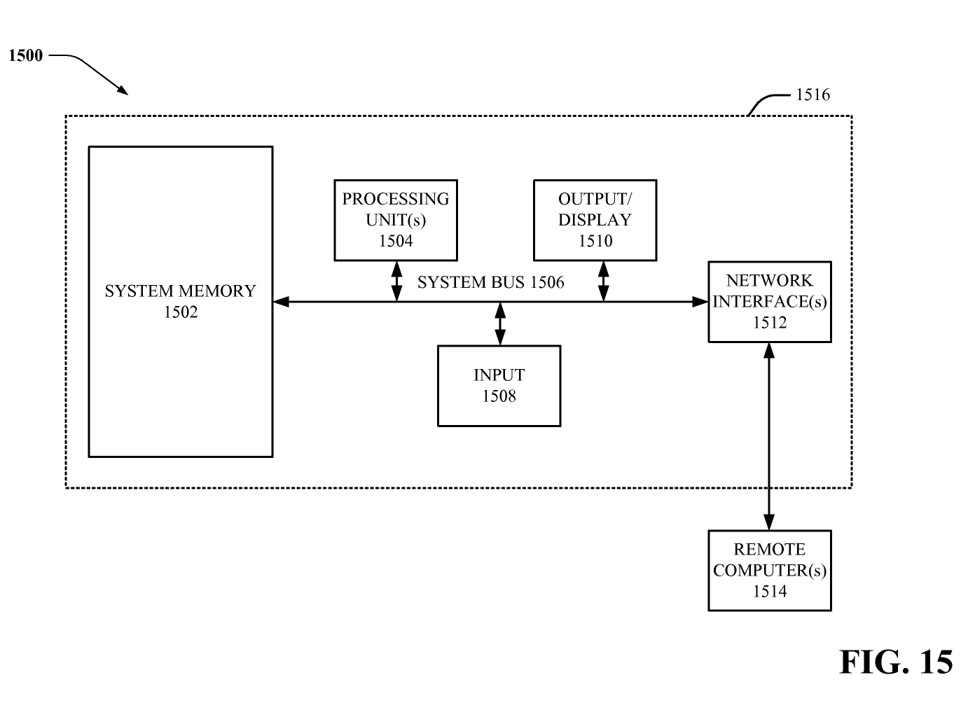

As mentioned, advantageously, the techniques described herein can be applied to any device where it is desirable to facilitate matrix generation and matrix utilization. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 15 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 15 thus illustrates an example of a suitable computing system environment 1500 in which one or aspects of the non-limiting embodiments described herein can be implemented, although as made clear above, the computing system environment 1500 is only one example of a suitable computing environment and is not intended to suggest any limitation as to scope of use or functionality. Neither should the computing system environment 1500 be interpreted as having any dependency or requirement relating to any one or combination of components illustrated in the exemplary computing system environment 1500.

With reference to FIG. 15, an exemplary remote device for implementing one or more non-limiting embodiments includes a general purpose computing device in the form of a computer 1516. Components of computer 1516 may include, but are not limited to, a processing unit 1504, a system memory 1502, and a system bus 1506 that couples various system components including the system memory to the processing unit 1504.

Computer 1516 typically includes a variety of computer readable media and can be any available media that can be accessed by computer 1516. The system memory 1502 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 1502 may also include an operating system, application programs, other program modules, and program data.

A user can enter commands and information into the computer 1516 through input devices 1508. A monitor or other type of display device is also connected to the system bus 1506 via an interface, such as output interface 1512. In addition to a monitor, computers can also include other peripheral output devices such as speakers and a printer, which may be connected through output interface 1512.

The computer 1516 may operate in a networked or distributed environment using logical connections to one or more other remote computers, such as remote computer 1512. The remote computer 1512 may be a personal computer, a server, a router, a network PC, a peer device or other common network node, or any other remote media consumption or transmission device, and may include any or all of the elements described above relative to the computer 1516. The logical connections depicted in FIG. 15 include a network, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described infra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” can include one criterion, or many criteria.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory having computer executable components stored thereon; and
a processor, communicatively coupled to the memory, configured to facilitate execution of the computer executable components, the computer executable components, comprising:
a tagging component configured to assign a tag to a content element in a media item;
a bidding component configured to determine a sponsor for the content element; and
a presentation component configured to present the tag with information regarding the content element, wherein the information regarding the content element is determined by the sponsor.

2. The system of claim 1, wherein the tag is a biddable keyword.

3. The system of claim 1, wherein the information regarding the content element includes a detailed description of the content element, an opportunity to purchase the content element or a uniform resource locator (URL) link associated with the content element.

4. The system of claim 1, wherein the bidding component selects the sponsor from one or more bidders.

5. The system of claim 4, wherein the bidding component selects the sponsor from the one or more bidders based at least in part on monetary payment.

6. The system of claim 4, wherein the bidding component selects the sponsor from the one or more bidders based at least in part on a determined relationship of the sponsor to the content element.

7. The system of claim 4, wherein the bidding component selects the sponsor from the one or more bidders based at least in part on a determined relevancy of the tag to the sponsor.

8. The system of claim 4, wherein the bidding component selects the sponsor from the one or more bidders based at least in part on a geographic location of the sponsor.

9. The system of claim 4, wherein the bidding component selects the sponsor from the one or more bidders based at least in part on a ranking of the one or more bidders.

10. The system of claim 1, wherein the content element includes a plurality of sponsors.

11. The system of claim 1, wherein the presentation component presents the information regarding the content element during playback of the media item.

12. The system of claim 1, further comprising a permission component that determines presentation rights for the tag.

13. The system of claim 12, wherein the presentation rights is determined based at least in part on geographic location.

14. The system of claim 12, wherein the presentation component presents the tag with the information regarding the content element based at least in part on the presentation rights.

15. A method, comprising:
employing at least one processor executing computer executable instructions embodied on at least one non-transitory computer readable medium to perform operations, comprising:
assigning a tag to a content element in a media item;
determining a sponsor for the content element; and
presenting the tag with information regarding the content element, wherein the information regarding the content element is determined by the sponsor.

16. The method of claim 15, wherein the determining the sponsor includes selecting the sponsor from one or more bidders based at least in part on monetary payment.

17. The method of claim 15, wherein the determining the sponsor includes selecting the sponsor from one or more bidders based at least in part on a determined relevancy of the tag to the sponsor.

18. The method of claim 15, wherein the determining the sponsor includes selecting the sponsor from one or more bidders based at least in part on geographic location of the sponsor.

19. A method, comprising:
offering, by a system including a processor, a tag associated with a content element in a media item for sponsorship;
receiving, by the system, one or more bids for the tag from one or more bidders; and
assigning, by the system, a sponsor for the tag based at least in part on the one or more bids for the tag.

20. The method of claim 19, wherein the assigning includes assigning, by the system, the sponsor for the tag based at least in part on monetary payment.

21. The method of claim 19, further comprising associating, by the system, information regarding the content element with the tag, wherein the information regarding the content element is determined by the sponsor.

22. A tangible computer-readable storage medium comprising computer-readable instructions that, in response to execution, cause a computing system including a processor to perform operations, comprising:
assigning a tag to a content element in a media item;
determining a sponsor for the content element; and
presenting the tag with information regarding the content element, wherein the information regarding the content element is determined by the sponsor.

23. The tangible computer-readable storage medium of claim 22, wherein the determining the sponsor includes selecting the sponsor from one or more bidders based at least in part on a determined relationship of the sponsor to the content element.

24. The tangible computer-readable storage medium of claim 22, wherein the determining the sponsor includes selecting the sponsor from one or more bidders based at least in part on a ranking of the one or more bidders.
